(19) United States
(12) Patent Application Publication
(10) Pub. No.: US 2026/0004771 A1
(43) Pub. Date: Jan. 1, 2026

(54) INJECTING SHORT-TERM SPECTRO-TEMPORAL KNOWLEDGE INTO AUTOMATIC SPEECH RECOGNITION MODELS

(71) Applicant: International Business Machines Corporation, Armonk, NY (US)

(72) Inventors: Takashi Fukuda, Tokyo (JP); Gakuto Kurata, Tokyo (JP)

(21) Appl. No.: 18/760,131

(22) Filed: Jul. 1, 2024

(51) Int. Cl. G10L 15/06; G10L 15/01

(52) U.S. Cl. CPC G10L 15/063; G10L 15/01; G10L 2015/0631

(57) ABSTRACT

Mechanisms are provided for training an Automatic Speech Recognition (ASR) model. An automatic speech recognition (ASR) computer model is trained based on full utterance training data, the ASR computer model having an audio encoder, text predictor, and a joint network which combines outputs of both the audio encoder and the text predictor. Fine-tuning training of the ASR computer model is performed by a knowledge distillation framework at least by: executing a chunking operation on full utterance data to generate a plurality of data chunks corresponding to full utterances in the full utterance data; and executing a knowledge distillation operation with two encoder embeddings. A first encoder embedding is obtained from the full utterance data and a second encoder embedding is obtained from the data chunks. Operational parameters of the trained ASR model are updated based on a loss determined from the first encoder embedding and second encoder embedding.

### BACKGROUND

The present application relates generally to an improved data processing apparatus and method and more specifically to an improved computing tool and improved computing tool operations/functionality for injecting short-term spectro-temporal knowledge into automatic speech recognition models.

Automatic speech recognition (ASR) is a computer technology in which an automated computing tool receives spoken language input, e.g., acoustic input data representing spoken words, and converts the input into a textual representation of the spoken language input. ASR is often found in user-facing applications such as live captioning, transcription services, note taking applications, virtual agents, conversation bots, and a plethora of other applications and services. ASR is sometimes also referred to as speech-to-text (STT) and voice recognition technology. ASR computing tools may use, or operated in conjunction with, natural language processing (NLP) models and/or other language models to perform various operations including sentiment analysis, text analytics, question answering, text summarization, and the like.

Many different types of ASR algorithms and models have been developed. For example, ASR algorithms may include statistics based algorithms and deep learning algorithms. Examples of statistical algorithms include dynamic time warping (DTW), Hidden Markov models (HMMs) and the like. With DTW, the algorithm seeks to find a best possible word sequence based on a distance between a plurality of time series that include a time series having unknown speech and other time series that have known words. With HMM, the algorithm is trained to predict word sequences by modifying parameters of the algorithm to increase the probability of the observed audio sequence being generated.

With deep learning ASR algorithms, a deep learning computer model may include a data preprocessor, neural acoustic model, and decoder. The data preprocessor extracts features from the audio input and pre-processes the extracted features to generate a spectrogram that is input to the neural acoustic model. The neural acoustic model output is provided to the decoder that may implement a language model, which decodes the output into a textual transcript.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method is provided for training an Automatic Speech Recognition (ASR) model. The method comprises training an automatic speech recognition (ASR) computer model based on full utterance training data, the ASR computer model having an audio encoder, text predictor, and a joint network which combines outputs of both the audio encoder and the text predictor. The method further comprises executing fine-tuning training on the trained ASR computer model at least by: receiving full utterance data as input to a knowledge distillation framework; executing, by the knowledge distillation framework, a chunking operation on the full utterance data to generate a plurality of data chunks corresponding to full utterances in the full utterance data; and executing, by the knowledge distillation framework, a knowledge distillation operation with two encoder embeddings. The two encoder embeddings comprise a first encoder embedding obtained from the full utterance data, and a second encoder embedding obtained from the data chunks corresponding to the full utterances in the full utterance data. Operational parameters of the trained ASR model are updated based on a loss determined from the first encoder embedding and second encoder embedding.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example diagram of the unified multi-form acoustic model, which implements a Conformer CTC model framework combined with knowledge distillation (KD) in accordance with one illustrative embodiment;

FIG. 3 is an example block diagram of an ASR model implementing the unified multi-form acoustic model of FIG. 2 in accordance with one illustrative embodiment; and

FIG. 4 is a flowchart outlining an example of a knowledge distillation phase of operation and fine-tuned training of a trained encoder for generating embeddings from full utterance inputs in accordance with one illustrative embodiment.

### DETAILED DESCRIPTION

The illustrative embodiments provide an improved computing tool and improved computing tool operations/functionality for injecting short-term spectro-temporal knowledge into automatic speech recognition (ASR) computer models. The illustrative embodiments, as discussed in greater detail hereafter, focus on improving ASR systems and their computer models with regard to full-utterance decoding for any type of input utterances. The illustrative embodiments improve the ASR models by using encoder embeddings created both from full-utterance and chunking training data, and knowledge distillation, which may in some illustrative embodiments utilize a masking mechanism to improve the knowledge distillation. The illustrative embodiments incorporate short-term acoustic knowledge via data chunking of full utterances into the ASR model without any degradation on long-form utterance inputs. The data chunking generates data chunks from the full utterances, with the data chunks being processed by a student network (encoder), and the full utterances are processed by a teacher network (encoder), with the resulting embeddings being used in a cross-entropy evaluation to improve the training of the student network. These data chunks provide the spectro-temporal knowledge for improving the ASR computer models. The trained student network may then be used to process full utterances of various types.

In accordance with at least one illustrative embodiment, an ASR model is augmented to implement a knowledge distillation engine in which a student network (encoder) operates on chunks of full utterances, and a teacher network (encoder) operates on the full utterances in training data. A training data chunking component splits the training utterances (full utterances) of the training data into short chunking data, each chunk corresponding approximately to the length of a portion, e.g., half, of a word, a single word, or multiple word, e.g., two-word, utterances which are smaller than a full utterance, e.g., less than a full sentence. During a knowledge distillation phase of operation, the chunks are input to the student encoder which computes an encoder embedding on each of the chunks and concatenates the embeddings obtained from the chunks. In a parallel path, the teacher encoder computes an encoder embedding from the original training utterance (full utterance). During the knowledge distillation phase, a cross-entropy loss is computed between the embedding from the student encoder and the embedding from the teacher encoder. The cross-entropy loss represents a knowledge that is used to fine tune a trained full-utterance model, e.g., the student network (encoder).

The illustrative embodiments operate on the observation that end-to-end (E2E) models have become the de-facto approach to automatic speech recognition (ASR) due to their remarkable performance and simplified training pipeline. To effectively handle various types of input utterances, dedicated acoustic models operating for specific applications are developed for these E2E models. The number of words in an utterance, such as long-form and short-form, is also a reason to create separate models for these different types of utterances and applications. For example, long-form utterances are dominant for closed captioning and call center conversations between humans, while short-form utterances mainly are observed in Interactive Voice Response (IVR) and car navigation systems to achieve a specific task between human and robot. In particular, short-form ASR systems also cover single word utterances such as a simple response with “yes”, “no” and “okay”, people/business names, and digits that do not significantly rely on language modeling.

Since acoustic properties between long-form and short-form utterances are quite different, even in similar recording conditions, for example due to speaking style and Lombard effect, simply mixing those utterances during training of a single model has unfortunately various negative effects. For example, a problem with ASR for diverse input utterances is the deletion problem, where massive continuous deletion errors are generated when the input audio is long and from unseen training conditions. It is observed not only for recurrent neural networks with an autoregressive structure such as Long Short Term Memory (LSTM) and Gated Recurrent Unit (GRU) neural networks, but also for those with a non-autoregressive structure such as Transformer or Conformer-based models. In such cases, the user may perceive the ASR system as being “stuck.” It has been recognized that this is mainly caused by data mismatch between training and test datasets used to train the neural networks and test them.

Simply increasing various single-word training utterances for the robustness on short-form ASR models results in the short-form ASR models suffering from an insertion problem. An insertion error occurs in an ASR model when the ASR model outputs a word that was not spoken by the speaker, e.g., an additional word is added to the transcription that was not part of the original spoken utterance. These insertion errors are especially observed when voice activity detection (VAD) (which may be built into the ASR) falsely labels short noise-only segments as speech, such as a cough, paper noise, keyboard typing, or any other “background” sound which has an audio duration similar to single word utterances. These insertion errors, and thus the insertion problem, may appear, for example, in transducer models, systems designed with greedy decoding, and situations in which the language model is not effective, for example. These two aforementioned problems occur frequently in existing ASR systems and their corresponding models.

To address these problems, the illustrative embodiments provide a single unified multi-form acoustic model that leverages knowledge distillation, as described hereafter, which performs well for various downstream applications without any changes regarding ASR output style, decoding strategy, and model topology compared to solutions that utilize separate dedicated models. The illustrative embodiments utilize both long-form utterances and chunk decoding to perform knowledge distillation and utilize that knowledge to fine-tune a full utterance computer model, e.g., a student network (encoder). The illustrative embodiments recognize that a model trained for chunk decoding is robust against the insertion problem and provides an improvement for short-form utterances. However, for long-form utterances, the model trained for chunk decoding works much worse than that trained for full utterance decoding. Thus, a single unified multi-form acoustic model is needed to address the performance issues as well as the insertion and deletion problems discussed above. The illustrative embodiments provide such a unified multi-form acoustic model which may be used to improve ASR system operations for all types of utterances.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an improved training of an ASR computer model by specifically utilizing a mix of both full utterance training and shorter chunk based training of the ASR computer model. The improved computing tool implements mechanism and functionality, such as a unified multi-form acoustic model, that uses a mixture of both full utterance, and data chunks obtained from the full utterance, in a teacher-student network framework to train an ASR model to generate a textual output prediction from a full utterance input, which cannot be practically performed by human beings either outside of, or with the assistance of, a technical environment, such as a mental process or the like. The improved computing tool provides a practical application of the methodology at least in that the improved computing tool is able to generate more accurate ASR predictions of textual representations of speech input for any type of utterance, e.g., long-form and short-form utterances.

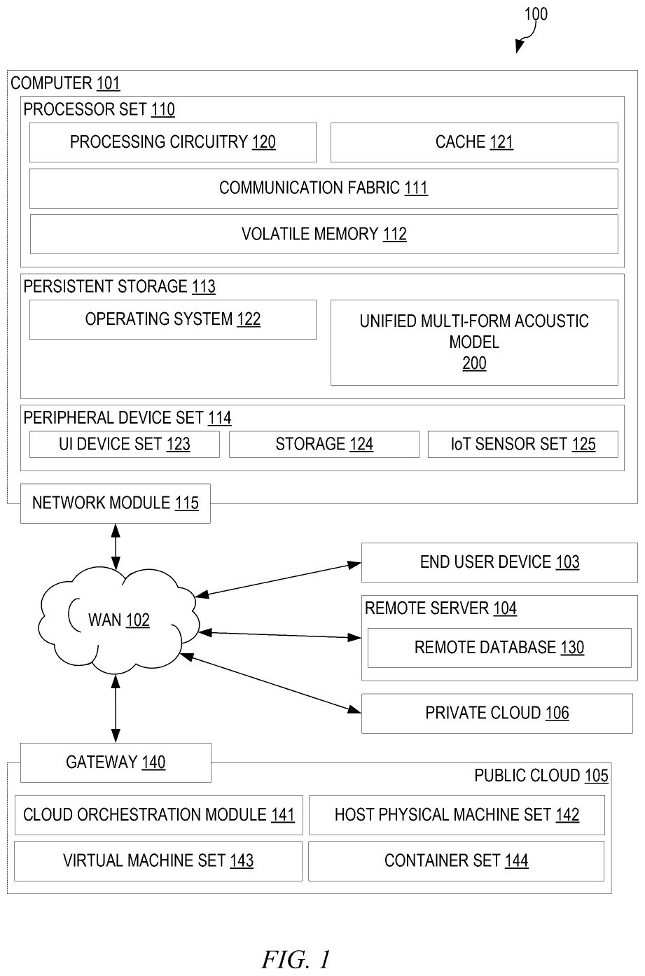

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as unified multi-form acoustic model 200. In addition to unified multi-form acoustic model 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and unified multi-form acoustic model 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in unified multi-form acoustic model 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in unified multi-form acoustic model 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a unified multi-form acoustic model 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates improved ASR operations based on improved training of the ASR models to mitigate deletion and insertion problems as discussed above.

As noted above, the illustrative embodiments provide an improved computing tool and improved computing tool operations/functionality for injecting short-term spectro-temporal knowledge into automatic speech recognition (ASR) computer models. With the mechanisms of the illustrative embodiments, computer models of an ASR system, e.g., neural network based ASR system, are improved in situations where word sequence information has little effectiveness in performing ASR operations. The mechanisms of the illustrative embodiments train a computer model for full-utterance input with encoder embeddings obtained from full utterance training data. The mechanisms of the illustrative embodiments additionally fine-tune the trained full-utterance model through a knowledge distillation operation with mixed encoder embeddings obtained both from the full utterance and shorter chunking data derived from the full utterance using a chunking module that splits the full utterance into predefined size chunks. A teacher network generates the encoder embedding from the full-utterance data and a student network generates the encoder embedding from the chunking data of the full-utterance to make encoder embedding pairs. The combined loss functions of these embeddings are used to train the student network to generate more accurate predictions of textual output for an input full utterance.

The illustrative embodiments will be described herein with reference to Conformer Connectionist Temporal Classification (CTC) models as examples, however it should be appreciated that the illustrative embodiments are not limited to Conformer CTC models and any other suitable machine learning computer model may be used in replacement of, or in addition to, the described Conformer CTC models without departing from the spirit and scope of the present invention. A Conformer CTC model is a non-autoregressive variant of the Conformer model used for ASR, and combines the strengths of both convolutional neural networks (CNNs) and transformers to model local and global dependencies in audio sequences. Unlike traditional autoregressive models, Conformer CTC uses CTC loss/decoding instead of transducer. Again, while the Conformer CTC model is used as an example herein due to its recognized accuracies in ASR tasks, the illustrative embodiments may utilize other machine learning computer models, such as other neural networks, acoustic models, and the like, without departing from the spirit and scope of the present invention. In addition, it should be recognized that references to “computer model” or simply “model” herein are intended to reference such machine learning computer models, such as neural networks or the like.

With the above in mind, in accordance with one or more illustrative embodiments, an improved computing tool and improved computing tool operations/functionality are provided that implements computer specific techniques for effectively training Conformer CTC models on mixed-form data from various diverse domains and sources. The one or more illustrative embodiments incorporate chunk-wise short-term discriminative knowledge distillation to the Conformer CTC model based system for better representation of short-term signals, and mitigates the above identified problems with regard to deletions and insertions for the resulting single unified model. Once the Conformer CTC based model has been trained, the same settings are used across all the ASR domains during testing.

Before discussing the illustrative embodiments in greater detail, it is first beneficial to have an understanding of CTC so that the improvements of the illustrative embodiments may be better understood. It should be appreciated that CTC computes the likelihood of a target sequence y by considering all the possible alignments for the labels with input length T. For the encoder output x from the last layer with target sequence y, the likelihood is defined as:

$${P}_{CTC} ( y \vert x ) = {\sum }_{a ∈ {β}^{- 1} ( y )} P ( a \vert x ) \qquad ( 1 )$$

where β⁻¹(y) is the set of alignments a of length T compatible with y including the special blank token, where the alignments are alignments of acoustic features with an output phoneme sequence. Tis the length of the input audio (length of acoustic feature sequence), x is the encoder output when the acoustic features are input to the CTC model, and y is a target sequence corresponding to the input acoustic features. P_{CTC}(y|x) is computed as the sum of probabilities of all possible alignments with blank symbols between the input and target label sequence. For example, if the target output symbol is “IBM”, CTC modeling considers all the combinations of output sequence, including blank tokens, such as “__I B M”, “_I_B M”, “I__BM”, etc., where “_” indicates the blank token and T is 5 in this example. CTC trains the model to maximize the sum of probabilities of all the output combinations.

The alignment probability P (a|x) is factorized with the following conditional independence assumption:

$$P ( a \vert x ) = {\prod }_{t} P ( {a}_{t} \vert {x}_{t} ) \qquad ( 2 )$$

where aₜ and xₜ denote the t-th symbol of a and the t-th representation vector of x, respectively. The CTC loss L_{CTC} with negative log-likelihood of P_{CTC}(y|x) is minimized to train the Conformer CTC model.

It should be appreciated that an intermediate CTC may be used as an additional constraint for regularization of the training of the Conformer CTC model. In such a case, an additional CTC loss L_{InterCTC} for the output, from an intermediate layer as a sub-model, is computed with P_{InterCTC}(y|x_{I}), where x_{I} is the encoder output from the intermediate layer, and is combined with the weighted sum of the two losses as:

$$ℒ = α {ℒ}_{CTC} + β {ℒ}_{InterCTC} \qquad ( 3 )$$

where alpha and beta are the weights, which may be determined empirically on a small amount of development data.

In accordance with the illustrative embodiments, in the knowledge distillation framework, training is performed in two separate steps. In a first step, complex teacher neural networks are initially trained using golden truth labels. Target acoustic models, or student networks, are then trained on the soft outputs of the teacher network using a cross entropy based training criterion that minimizes the difference between the student and teacher distributions using a loss function of the type:

$$ℒ = - {\sum }_{i} {q}_{i} ( f ) log {p}_{i} ( f ) \qquad ( 4 )$$

where i is a golden truth label index, qᵢ(f) is the so-called soft label from the teacher network with input feature f, which works as a pseudo label, pᵢ(f) is output probability of the class from the student network.

Although knowledge distillation is used to mimic complicated teacher networks with a simple student network for improved latency and memory footprint, this framework is used in the illustrative embodiments to incorporate short-term acoustic knowledge into the final full utterance model used for decoding and, at the same time, to prevent over-fitting to utterances that are split into short chunks. Specifically the encoder output from the teacher encoder, i.e., teacher neural network computer model, is generated from whole utterance inputs and provided as a teacher representation to be combined with the output from the student encoder, i.e., student neural network computer model, generated from the small chunk sequence. Mixing chunked data as an additional training operation provides good acoustic knowledge to the full utterance based encoding. The Conformer CTC model framework of the illustrative embodiments described herein is used in order to not over-train on short-term data chunks.

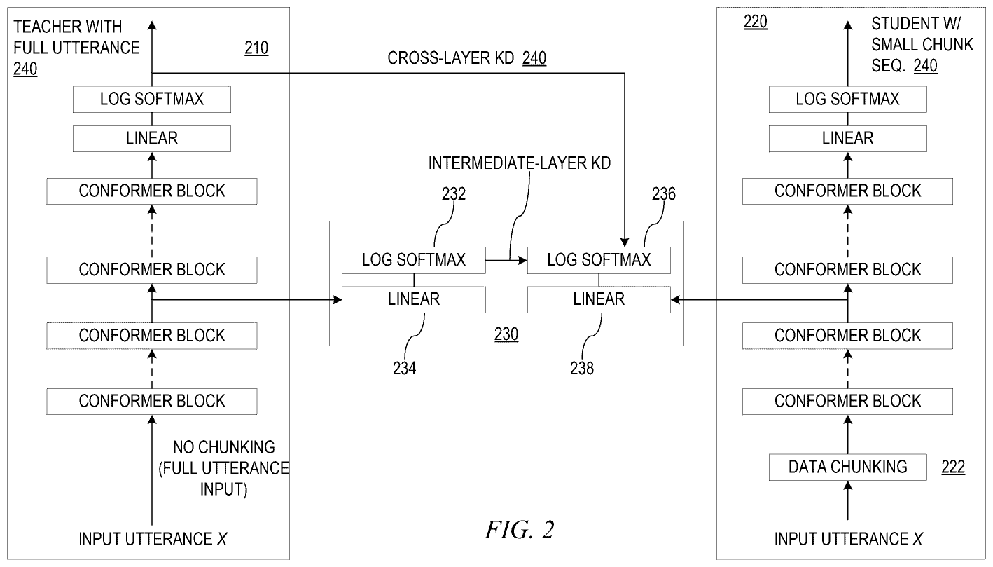

FIG. 2 is an example diagram of the unified multi-form acoustic model, which implements a Conformer CTC model framework combined with knowledge distillation (KD) in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., speech input providing the full utterances, and the resulting output may aid human beings, e.g., textual transcripts of the full utterances. The invention is specifically directed to the automatically operating computer components directed to improving the way that ASR is performed, and providing a specific solution to the deletion and insertion problems of other ASR systems by specifically providing a unified multi-form acoustic model that is trained using knowledge distillation on full utterances by implementing chunking of the full utterances and evaluation of a combined loss as described hereafter.

As shown in FIG. 2, the Conformer CTC model training framework of the unified multi-form acoustic model 200 comprises a teacher network (or encoder) 210 and a student network (or encoder) 220. Each of these networks or encoders 210, 220 are Conformer CTC networks with a plurality of Conformer blocks, a linear (or fully connected) layer which connects every input neuron to every output neuron, followed by a log softmax layer that maps a vector output for the linear layer into a probability distribution for classification. Each Conformer block may comprise four modules stacked together, i.e., a feed-forward module, a self-attention module, a convolution module, and a second feed-forward module. Notably, the student network 220 includes a data chunking module 222 that operates on the full utterance input X to split the full utterance into chunks that are processed through the remainder of the student network 220.

In addition, an intermediate layer 230, which may comprise elements of the teacher network (encoder) 210 and the student network (encoder) 220. As shown in FIG. 2, this intermediate layer 230 comprises linear and log softmax layers 232-238 which operate to improve the training of the student network 220 based on knowledge distillation from the data chunking performed by the data chunking module 222. As one example, linear and log softmax layers 232-234 may be part of the teacher network 210 while linear and log softmax layers 236-238 may be part of the student network 220. The differences between values of the log softmax layers 232-234 of the teacher network 210 and those of the log softmax layers 236-238 of the student network 220 are back propagated to the student network 220 with cross-entropy criteria to update the parameters in the student model 220.

The illustrative embodiments focus on a distillation/regularization technique that targets the intermediate layer 230 of the teacher network 210 and student network 220, with chunking data input, from the data chunking module 222, because the objective is to make the student network 220 acoustically more discriminative for short utterance input. Representations for acoustic characteristics, including low level feature extraction, are expected to be performed in a lower dimensional area of the student network 220. Therefore, it is assumed that regularizing the network training for the lower intermediate layer is more effective than using the final layer. In the illustrative embodiments, this framework is applied to a pre-trained Conformer CTC model, e.g., student network 220 (without the data chunking component 222) as an additional training operation to fine tune and further improve the Conformer CTC model (e.g., student network 220).

A pre-trained Conformer CTC model is used as a teacher network 210 with its parameters fixed at the training. The student network 220, which is initialized with the same parameters as the teacher network 210 at the beginning of this additional training operation, is updated with chunking data, which will be used to fine tune the final student network 220.

Distillation of the short-term knowledge from the chunks of the training data, i.e., the full utterances, generated by the data chunking module 222 is performed with a logmel feature (log Mel filterbank features based on frequency analysis using Fourier transform and auditory filtering) input from the whole or full utterance f_{w} for the teacher network 210, and from the chunked feature sequence f_{c} for the student network 220 as generated by the data chunking module 222, as follows:

$${ℒ}_{InterKD} = - {\sum }_{i} {Q}_{InterCTC} ( y \vert {x}_{I - fw} ) log {P}_{InterCTC} ( y \vert {x}_{I - fc} ) \qquad ( 5 )$$

where X_{I-fc} and X_{I-fw} are encoder outputs from the intermediate layer 230 when f_{w} and f_{c} are inputs to the teacher network 210 and student network 220, respectively. The student network 220 is trained on the combined loss between two CTC output layers (see equation (3) above) and the knowledge distillation (KD) loss for the intermediate layer 230 as follows:

$$ℒ = α {ℒ}_{CTC} + β {ℒ}_{InftrCTC} + γ {ℒ}_{InterKD} \qquad ( 6 )$$

where γ is the weight for the distillation loss. The weights of the teacher network 210, i.e., internal weights of the internal nodes of the teacher network 210, are fixed during training. In addition, a cross-layer knowledge distillation (KD) 240, from the last teacher network 210 layer, is used in the log softmax layer 236 of the student network portion of the intermediate layer 230, with the KD loss L_{CrossKD} for better robustness and regularization as follows:

$${ℒ}_{CrossKD} = - {\sum }_{i} {Q}_{InterCTC} ( y \vert {x}_{L - fw} ) log {P}_{InterCTC} ( y \vert {x}_{I - fc} ) \qquad ( 7 )$$

where X_{L-fw} is the teacher network (encoder) 210 output from the last layer, i.e., cross-layer KD 240, based on the whole or full utterance. The combined loss is defined with the loss weight 8 for the new KD loss L_{CrossKD} as follows:

$$ℒ = α {ℒ}_{CTC} + β {ℒ}_{InterCTC} + γ {ℒ}_{InterKD} + δ {ℒ}_{CrossKD} \qquad ( 8 )$$

This combined loss is used to update the internal parameters of the student network 220 through a back propagation process. It should be noted that this combined loss is used to train the student network 220 and is not used to train the combination of the teacher and student networks.

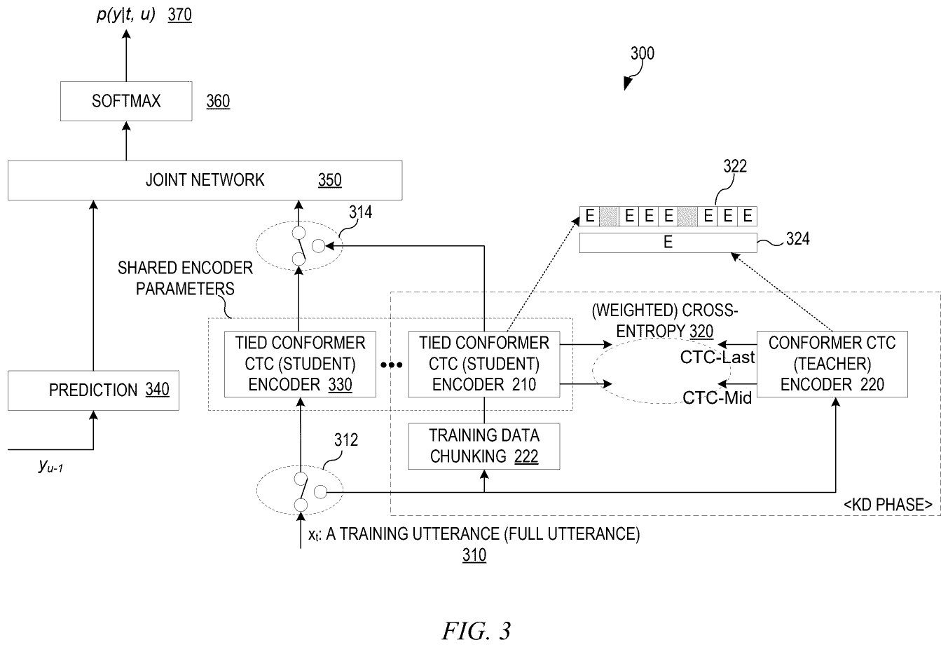

FIG. 3 is an example block diagram of a transducer-based ASR model implementing the unified multi-form acoustic model 200 of FIG. 2 in accordance with one illustrative embodiment. As shown in FIG. 3, the unified multi-form acoustic model 200 is used as part of a knowledge distillation phase (KD phase) of operation to fine tune the training of a full utterance trained student network (encoder) 210 for deployment as part of the ASR model 300 for runtime processing of full utterances of various types. As shown in FIG. 3, switches 312 and 314 are used to switch between full-utterance input and chunking data input while training the student network in a KD phase, where the switches are closed during training operation such that full utterance inputs 310 flow through trained encoder 330 to the joint network 350. The switches 312 and 314 are removed in runtime operation. During a training (KD phase) of the encoder 330, which is a fine-tuned version of the student network (encoder) 210 fine-tuned according to the illustrative embodiments, the switches are opened to cause the flow of training utterances (xₜ) 310 to be input to the training data chunking module 222 and the teacher network (encoder) 220. It should be appreciated that the switches 312 and 314 are conceptual and may not be implemented as actual physical switches, but instead are depicted to illustrate a separation between full-utterance input and chunking data input while fine-tuning the encoder 210 to make the fine-tuned network (encoder) 330 part of the ASR model 300.

It should be appreciated that initially, the student network (encoder) 210 is trained for full utterances in a similar manner to that of the teacher network (encoder) 220, but through the operation of the illustrative embodiments, is fine-tuned through additional training based on the training data chunking from module 222 to thereby generate a fine-tuned version of the student network 210 which may then be deployed as fine-tuned network or encoder 330. In performing the fine-tuning training via the KD phase of operation, the training utterance (full utterance) is input to the training data chunking module 222 and the teacher network (encoder) 220. The training data chunking module 222 splits the training utterance 310 into short chunking data by way of a chunking algorithm. The chunking algorithm, in some illustrative embodiments, splits the training utterance 310 into chunks that are approximately the length of a predetermined portion of a word (e.g., half a word), a single word, or multiple words (e.g., two-word).

Having generated the chunks of the full utterance via the training data chunking module 222, the student network (encoder) 210 computes an encoder embedding on each of the chunks and concatenates these embeddings to generate the embedding 322. In some illustrative embodiments, the student encoder 210 embeddings may be randomly masked for further stability and robustness by increasing generalizability of the student encoder 210 by compensating missing portions from the masking (regarded as noise in the encoder output) with other embedding data in the same minibatch of the training.

In addition to the embedding 322 generated by the student network (encoder) 210 based on the chunk data from the training data chunking module 222, the teacher network (encoder) 220 receives as input the full utterance and generates a full utterance embedding 324. The chunk based embedding 322 from the student network (encoder) 210 and the full utterance embedding 324 from the teacher network (encoder) 220 are used to compute a cross entropy loss between these embeddings 320, e.g., CTC-Mid is the encoder embedding from a part of the teacher and student networks, e.g., a middle layer, to compute an intermediate layer KD loss, as shown in FIG. 2. CTC-Last is the encoder embedding from the last layer which is used in computing cross-layer KD loss. The cross entropy loss is used to update the student network (encoder) 210 training and the other losses, as described above with regard to equation (8), to generate a combined loss that is the basis for the machine learning training algorithm to modify the operational parameters of the student network (encoder) 210 to reduce this loss when generating embeddings. This fine-tuning training may be performed with regard to each of the training utterances in a training dataset until a convergence criterion is met, e.g., the combined loss is equal to or below a predetermined threshold or a predetermined number of iterations or epochs of the training have occurred.

In some illustrative embodiments, an annealed blending ratio for the chunking data may be utilized to update the student network (encoder) 210. That is, the ratio of chunking data, i.e., percentage of chunking data relative to full utterance data, for fine-tuning the student network (encoder) 210 may be gradually increased until a predetermined performance is achieved, e.g., accuracy or the like. The training and performance evaluations may be determined based on ground truth data in the training dataset, e.g., to determine losses, evaluate accuracy of the embeddings, and the like.

Once the KD phase based fine-tuning training of the student network (encoder) 210 is complete, the fine-tuned student network (encoder) is deployed as encoder 330 for use in runtime operation. As shown in FIG. 3, the deployed fine-tuned encoder 330 operates on full utterances of various types 310 as input and provides embeddings of these full utterances to the joint network 350, which also receives text predictions 340 from a text predictor (not shown). The joint network 350 combines the outputs of the fine-tuned encoder 330, which is an audio encoder, with the text predictions from the text predictor. The output of the joint network 350 is passed through the softmax layer 360 which outputs the conditional distribution p(y|t, u) of an output sequence y=(y_{I}, . . . , y_{U}) of length U for an input feature sequence, where t is an index of time and u is an index of a target character sequence.

In some illustrative embodiments, the training data chunking module 222 may perform chunk swapping prior to inputting the chunks to the student network (encoder) 210. That is, the training data chunking module 222 may swap adjacent chunks and compute an encoder embedding on each of the swapped chunks. It is assumed that adjacent chunks are acoustically/phonetically similar and do not have a significant difference. By mildly cutting off the continuity of the input speech sequence represented in the full utterance with the chunk swapping, over-fitting of the training to the full utterance input is reduced.

Thus the illustrative embodiments provide an improved computing tool and improved computing tool operations/functionality for injecting short-term spectro-temporal knowledge into automatic speech recognition (ASR) computer models. In particular, the illustrative embodiments utilize a fine-tuning training of a trained encoder via a knowledge distillation phase of operation using a combination of full utterance embeddings and chunk based embeddings. In doing so, the illustrative embodiments minimize deletion and insertion problems in generating embeddings and thus, improve the accuracy of the results output by the ASR model.

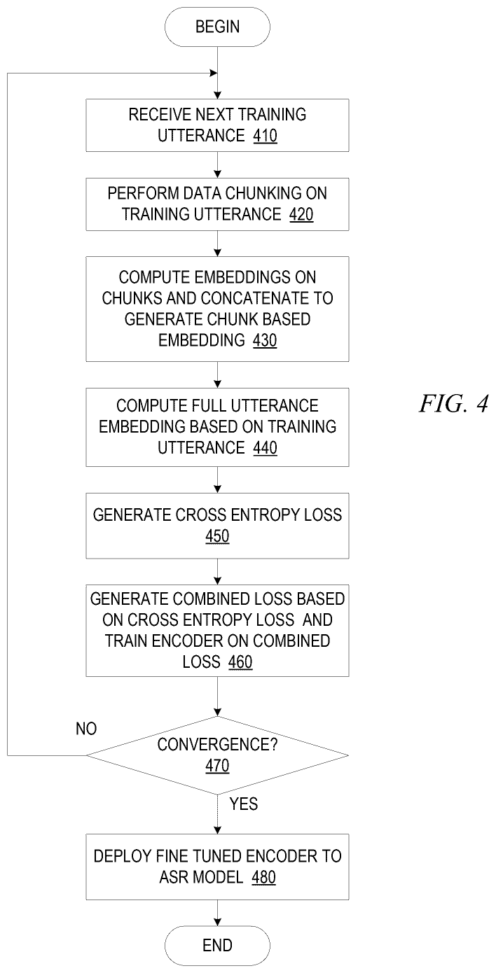

FIG. 4 presents a flowchart outlining example operations of elements of the present invention with regard to one or more illustrative embodiments. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

FIG. 4 is specifically directed to the knowledge distillation phase of operation and the specific fine-tuned training of an already trained encoder, e.g., a neural network, for generating embeddings from full utterance inputs. As shown in FIG. 4, the operation starts by receiving a next training utterance (full utterance) from a training dataset as input (step 410). The training utterance is input to a training data chunking module which splits the training utterance into short chunking data (step 420). The chunks of data of the full utterance are input to a student network (encoder) which computes an embedding on each of the chunks and concatenates the embeddings to generate a chunk based embedding (step 430). This operation, in some illustrative embodiments, may further include random and/or weighted masking to increase the robustness of the improvement of the illustrative embodiments.

In addition, the training utterance (full utterance) is input to a teacher network (encoder) which generates a full utterance embedding (step 440). A cross entropy loss is generated based on the chunk based embedding and the full utterance embedding (step 450). The cross entropy loss is combined with other losses of the student network (encoder) and a machine learning training algorithm to update the operational parameters of the student network (encoder) (step 460). For example, the machine learning training algorithm operates to reduce the combined loss by modifying the operational parameters to cause the student network (encoder) to generate results that are closer to a ground truth specified in the training dataset for the full utterance.

A determination is made as to whether a convergence criterion is achieved, e.g., the combined loss is equal to or less than a predetermined threshold or a predetermined number of iterations/epochs have occurred (step 470). If not, the operation returns to step 410 and the process is repeated for the next training utterance in the training dataset. If a convergence criterion is achieved, then the fine-tuned student network (encoder) is deployed as part of the ASR model for runtime operation on various full utterances (step 480). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for training an Automatic Speech Recognition (ASR) model, the method comprising:
training an automatic speech recognition (ASR) computer model based on full utterance training data, the ASR computer model having an audio encoder, text predictor, and a joint network which combines outputs of both the audio encoder and the text predictor; and
executing fine-tuning training on the trained ASR computer model at least by:
receiving full utterance data as input to a knowledge distillation framework;
executing, by the knowledge distillation framework, a chunking operation on the full utterance data to generate a plurality of data chunks corresponding to full utterances in the full utterance data; and
executing, by the knowledge distillation framework, a knowledge distillation operation with two encoder embeddings, wherein the two encoder embeddings comprise a first encoder embedding obtained from the full utterance data, and a second encoder embedding obtained from the data chunks corresponding to the full utterances in the full utterance data, wherein operational parameters of the trained ASR model are updated based on a loss determined from the first encoder embedding and second encoder embedding.

2. The computer-implemented method according to claim 1, wherein a teacher encoder of the knowledge distillation framework generates the first encoder embedding from the full utterance data, and a student encoder of the knowledge distillation framework generates the second encoder embedding from the chunking data, and wherein the loss is based on a cross-entropy loss computed between the first encoder embedding from the teacher encoder and the second encoder embedding from the student encoder.

3. The computer-implemented method according to claim 2, wherein the loss is an interpolated loss between a transducer loss and the cross entropy loss, and wherein the audio encoder of the ASR computer model shares one or more encoder parameters with the student encoder.

4. The computer-implemented method according to claim 2, wherein the student encoder masks one or more portions of embeddings generated by the student encoder, such that the first encoder embedding comprises a first portion having encodings corresponding to the data chunks, and a second portion having masked encodings.

5. The computer-implemented method according to claim 2, wherein the knowledge distillation is executed at an intermediate layer of the teacher encoder and student encoder with a cross-layer knowledge distillation loss.

6. The computer-implemented method according to claim 2, wherein the chunking operation further comprises swapping adjacent data chunks prior to inputting the data chunks into the student encoder.

7. The computer-implemented method according to claim 2, wherein the chunking operation further comprises implementing an annealed scheduling for data chunk generation, wherein the annealed scheduling comprises a gradual increase of a ratio of data chunks to full utterances until a predetermined performance metric is reached for the student encoder.

8. The computer-implemented method according to claim 1, wherein each data chunk corresponds to a portion of a single word or a short utterance comprising multiple words but less than a corresponding full utterance in the full utterance data.

9. The computer-implemented method according to claim 1, wherein the operational parameters of the trained ASR model are operational parameters of the student encoder, and wherein the student encoder is deployed as the audio encoder of the ASR model after execution of the fine-tuning is complete.

10. A computer program product comprising a computer readable storage medium having a computer readable program stored therein, wherein the computer readable program, when executed on a computing device, causes the computing device to:
train an automatic speech recognition (ASR) computer model based on full utterance training data, the ASR computer model having an audio encoder, text predictor, and a joint network which combines outputs of both the audio encoder and the text predictor; and
execute fine-tuning training on the trained ASR computer model at least by:
receiving full utterance data as input to a knowledge distillation framework;
executing, by the knowledge distillation framework, a chunking operation on the full utterance data to generate a plurality of data chunks corresponding to full utterances in the full utterance data; and
executing, by the knowledge distillation framework, a knowledge distillation operation with two encoder embeddings, wherein the two encoder embeddings comprise a first encoder embedding obtained from the full utterance data, and a second encoder embedding obtained from the data chunks corresponding to the full utterances in the full utterance data, wherein operational parameters of the trained ASR model are updated based on a loss determined from the first encoder embedding and second encoder embedding.

11. The computer program product according to claim 10, wherein a teacher encoder of the knowledge distillation framework generates the first encoder embedding from the full utterance data, and a student encoder of the knowledge distillation framework generates the second encoder embedding from the chunking data, and wherein the loss is based on a cross-entropy loss computed between the first encoder embedding from the teacher encoder and the second encoder embedding from the student encoder.

12. The computer program product according to claim 11, wherein the loss is an interpolated loss between a transducer loss and the cross entropy loss, and wherein the audio encoder of the ASR computer model shares one or more encoder parameters with the student encoder.

13. The computer program product according to claim 11, wherein the student encoder masks one or more portions of embeddings generated by the student encoder, such that the first encoder embedding comprises a first portion having encodings corresponding to the data chunks, and a second portion having masked encodings.

14. The computer program product according to claim 11, wherein the knowledge distillation is executed at an intermediate layer of the teacher encoder and student encoder with a cross-layer knowledge distillation loss.

15. The computer program product according to claim 11, wherein the chunking operation further comprises swapping adjacent data chunks prior to inputting the data chunks into the student encoder.

16. The computer program product according to claim 11, wherein the chunking operation further comprises implementing an annealed scheduling for data chunk generation, wherein the annealed scheduling comprises a gradual increase of a ratio of data chunks to full utterances until a predetermined performance metric is reached for the student encoder.

17. The computer program product according to claim 10, wherein the operational parameters of the trained ASR model are operational parameters of the student encoder, and wherein the student encoder is deployed as the audio encoder of the ASR model after execution of the fine-tuning is complete.

18. An apparatus comprising:
at least one processor; and
at least one memory coupled to the at least one processor, wherein the at least one memory comprises instructions which, when executed by the at least one processor, cause the at least one processor to:
train an automatic speech recognition (ASR) computer model based on full utterance training data, the ASR computer model having an audio encoder, text predictor, and a joint network which combines outputs of both the audio encoder and the text predictor; and
execute fine-tuning training on the trained ASR computer model at least by:
receiving full utterance data as input to a knowledge distillation framework;
executing, by the knowledge distillation framework, a chunking operation on the full utterance data to generate a plurality of data chunks corresponding to full utterances in the full utterance data; and
executing, by the knowledge distillation framework, a knowledge distillation operation with two encoder embeddings, wherein the two encoder embeddings comprise a first encoder embedding obtained from the full utterance data, and a second encoder embedding obtained from the data chunks corresponding to the full utterances in the full utterance data, wherein operational parameters of the trained ASR model are updated based on a loss determined from the first encoder embedding and second encoder embedding.

19. The apparatus according to claim 18, wherein a teacher encoder of the knowledge distillation framework generates the first encoder embedding from the full utterance data, and a student encoder of the knowledge distillation framework generates the second encoder embedding from the chunking data, and wherein the loss is based on a cross-entropy loss computed between the first encoder embedding from the teacher encoder and the second encoder embedding from the student encoder.

20. The apparatus according to claim 19, wherein the chunking operation further comprises at least one of swapping adjacent data chunks prior to inputting the data chunks into the student encoder, or implementing an annealed scheduling for data chunk generation, wherein the annealed scheduling comprises a gradual increase of a ratio of data chunks to full utterances until a predetermined performance metric is reached for the student encoder.
